(19) United States
(12) Patent Application Publication
(10) Pub. No.: US 2013/0033124 A1
(43) Pub. Date: Feb. 7, 2013

(54) VOICE COIL MOTOR

(71) Applicants: YU-BIN WANG, Tu-Cheng (TW); CHUN-FU WU, Tu-Cheng (TW)

(72) Inventors: YU-BIN WANG, Tu-Cheng (TW); CHUN-FU WU, Tu-Cheng (TW)

(73) Assignee: HON HAI PRECISION INDUSTRY CO., LTD., Tu-Cheng (TW)

(21) Appl. No.: 13/327,769

(22) Filed: Dec. 16, 2011

(30) Foreign Application Priority Data
Aug. 3, 2011 (TW) 100127498

(51) Int. Cl. H02K 41/035

(52) U.S. Cl. 310/12.16

(57) ABSTRACT

A voice coil motor includes a housing, a movable barrel, at least two magnetic elements, and a coil received in the housing. The housing defines an accommodating room, and includes a top panel, at least two peripheral panels perpendicular to the top panel, and at least two fixing plates extending in the accommodating room. The at least two magnetic elements are surrounding the movable barrel. Each magnetic element has a first magnetic pole aligned with a corresponding fixing plate and a second magnetic pole fixed on the housing. The coil is sleeved on the movable barrel and is between the fixing plates and the first magnetic poles.

### BACKGROUND

1. Technical Field

The present disclosure relates to lens actuators, and particularly, to a voice coil motor.

2. Description of Related Art

Variable focal length lenses are widely used in optical systems. Optical systems incorporating such lenses can provide focused images of objects at varying distances without adjusting the distance between the lens and the image plane, for example. Variable focal length lenses can also be used in optical systems that provide varying magnification without changing the lenses. Many optical systems include an actuator, such as a step motor, to drive the lenses. However, the step motor is relatively large in volume. Use of the step motor requires a significant amount of space for movement of the lenses, which makes the optical system bulky.

Therefore, it is desirable to provide a voice coil motor that can overcome the above-mentioned limitations.

### BRIEF DESCRIPTION OF THE DRAWINGS

Many aspects of the embodiments should be better understood with reference to the following drawings. The components in the drawings are not necessarily drawn to scale, the emphasis instead being placed upon clearly illustrating the principles of the present disclosure. Moreover, in the drawings, like reference numerals designate corresponding parts throughout the several views.

FIG. 1 is a schematic view of a voice coil motor, according to an exemplary embodiment.

FIG. 2 is an exploded view of the voice coil motor of FIG. 1.

FIG. 3 is an exploded view of a housing of the voice coil motor of FIG. 1.

FIG. 4 is a schematic view of a movable barrel of the voice coil motor of FIG. 1.

FIG. 5 is a schematic view of a first resilient plate of the voice coil motor of FIG. 1.

FIG. 6 is a schematic view of a second resilient plate of the voice coil motor of FIG. 1.

FIG. 7 is a cross-sectional view of the voice coil motor of FIG. 1.

### DETAILED DESCRIPTION

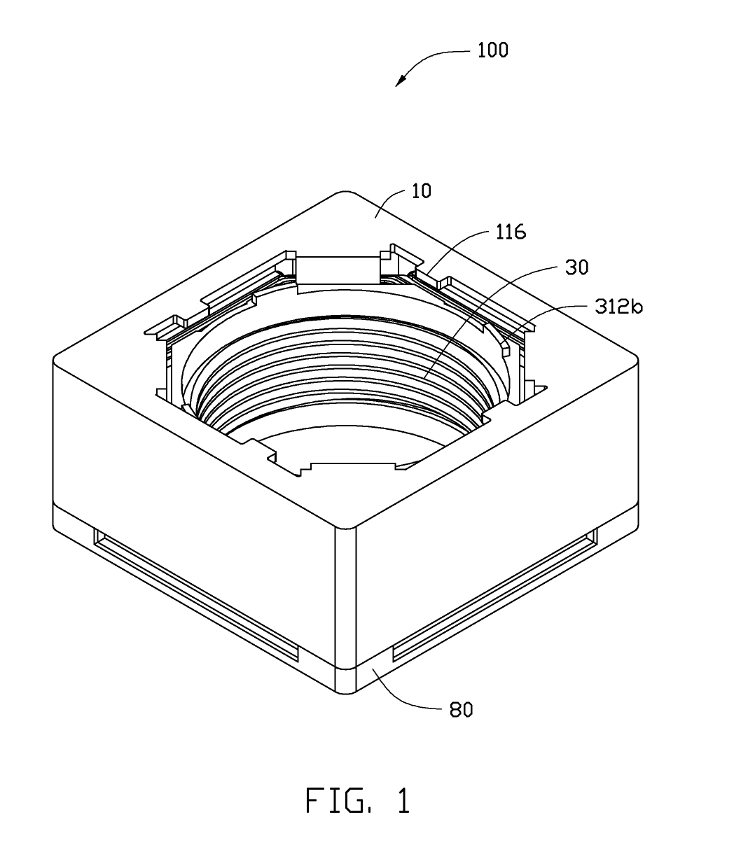

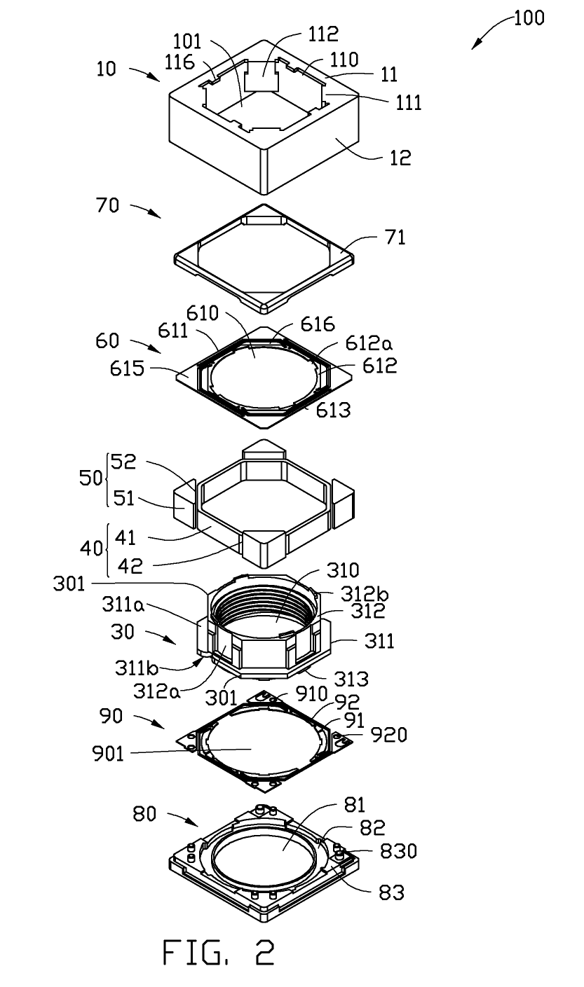

Referring to FIG. 1 and FIG. 2, a voice coil motor 100, according to an embodiment, includes a cuboid housing 10, a square-shaped loading plate 80, a movable barrel 30, a coil 40, four magnetic elements 50, a square-shaped first resilient plate 60, a pressing plate 70, and a square-shaped second resilient plate 90. The loading plate 80 can cover the housing 10 to form a first accommodating room 101.

The housing 10 is made of high permeability alloy, such as yoke iron. The housing 10 includes a substantially square-shaped top panel 11, and four peripheral panels 12 perpendicular to the top panel 11. The top panel 11 defines a first through hole 110 at a center, and includes four first fixing portions 111 at four corners, four baffle plates 116 extending from an inner sidewall of the first through hole 110 towards a center of the first through hole 110. In addition, four fixing plates 112 perpendicularly extend from the four first fixing portions 111 towards the first accommodating room 112 respectively. In this embodiment, each of the four baffle plates 116 is disposed between two adjacent first fixing portions 111.

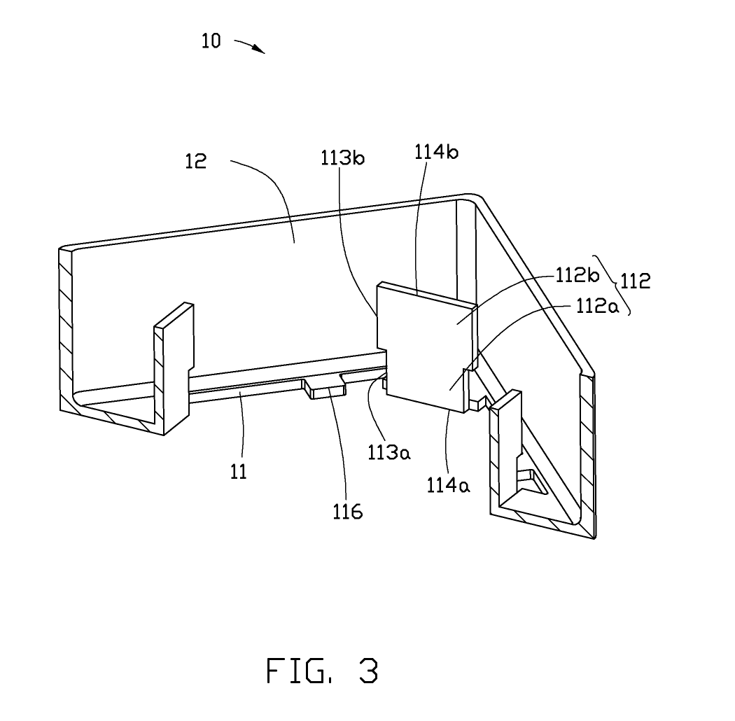

Also referring to FIG. 3, each fixing plate 112 includes a first straight portion 112a adjacent to the top panel 11 and a second straight portion 112b extending from the first straight portion 112a. The first straight portion 112a includes a first long edge 113a and a wide edge 114a perpendicular to the first long edge 113a. The second straight portion 112b includes a second long edge 113b and a second wide edge 114b perpendicular to the second long edge 113b. The first long edge 113a and the second long edge 113b are parallel to a center axis of the first accommodating room 101. The first wide edge 113b and the second wide edge 114b are perpendicular to the center axis of the first accommodating room 101. The first wide edge 114a is shorter than the second wide edge 114b.

The loading plate 80 is made of non-magnetic material (such as plastic), and defines a second through hole 81 at a center coaxial with the first through hole 110. The loading plate 80 further defines a ring-shaped slot 82 coaxial with the second through hole 81. The loading plate 80 has four second fixing portions 83 at four corners corresponding to the four first fixing portions 111. A number of locating rods 830 are arranged on a surface of each of the four second fixing portions 83 facing the top panel 11.

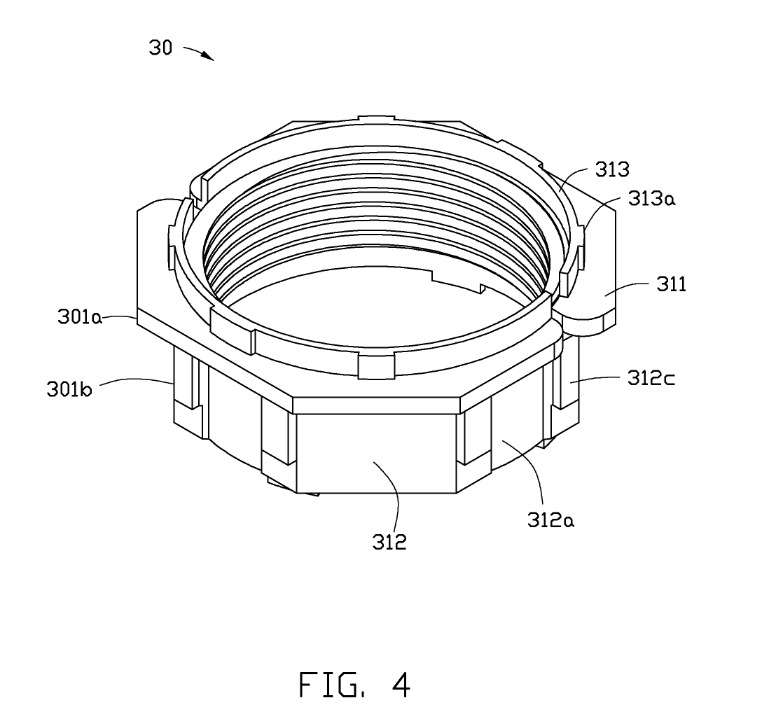

Also referring to FIG. 4, the movable barrel 30 is moveably received in the first accommodating room 101, defining a second accommodating room 310 at a center coaxial with the first accommodating room 101. The second accommodating room 310 is a through hole, and receives a lens module (not shown). The moveable barrel 30 includes an octahedral-shaped base 311, an octahedral-shaped first protrusion 312 extending from the base 311 towards the top panel 11, and a cylindrical second protrusion 313 extending from the base 311 towards the loading plate 80. The first protrusion 312 and the second protrusion 313 are coaxial with the base 311. The base 311 has eight first side edges 301a. The first protrusion 312 has eight second side edges 301b. The first side edges 301a and the second side edges 301b are parallel to a center axis of the second accommodating room 310.

The distance between the center axis of the second accommodating room 310 and each first side edge 301a is larger than the distance between the center axis of the second accommodating room 310 and each second side edge 301b. As well, larger than an outer radius of the second protrusion 313, and thus forms a first surface 311a between the base 311 and the first protrusion 312, and a second surface 311b between the base 311 and the second protrusion 313. A number of first locating blocks 312b are arranged on a surface of the first protrusion 312 facing the top panel 11.

The first protrusion 312 has four sidewalls 312c corresponding to the four fixing plates 112. Each sidewall 312c defines a notch 312a for receiving the corresponding fixing plate 112. A number of second locating blocks 313a are arranged on an outer surface of the second protrusion 313.

The coil 40 sleeves on the movable barrel 30, and is loaded on the first surface 311a. The coil 40 is substantially regular octagon-shaped, and includes four lateral surfaces 41 parallel to the four corresponding peripheral panels 12 and four connecting surfaces 42. Each of the connecting surfaces 42 is connected between each two adjacent lateral surfaces 41 respectively. The four connecting surfaces 42 and the housing 10 form four receiving spaces 43.

The four magnetic elements 50 are substantially right triangle-shaped, and are received in the four receiving spaces 43 respectively surrounding the movable barrel 30. Each of the four magnetic elements 50 includes two vertical surfaces 51 perpendicular to each other and an inclined surface 52 connected between the two vertical surfaces 51. The housing 10 attracts the two vertical surfaces 51. The inclined surface 52 faces the corresponding connecting surface 42, and is not in contact with the connecting surface 42, and thus the movable barrel 30 can move with respect to the magnetic elements 50 along the axial direction of the first accommodating room 101. The inclined surface 52 is a first magnetic pole 57 (i.e. S pole) aligned with a corresponding fixing plate 112. A part portion of the magnetic element 50 away from the inclined surface 52 is a second magnetic pole 56 (i.e. N pole). The coil 40 is disposed between the four first magnetic poles 57 and the four fixing plates 112. In this embodiment, the magnetic element 50 is a magnet.

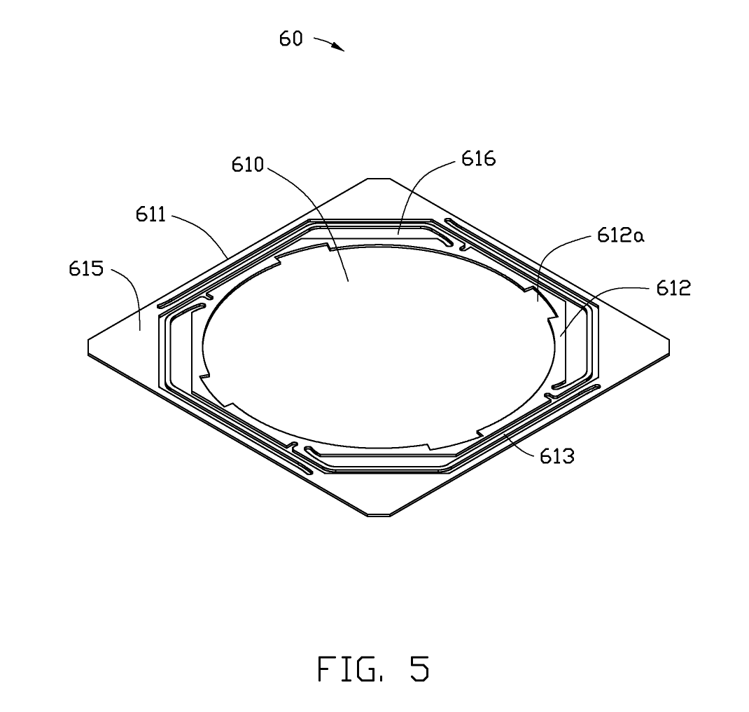

Referring also to FIG. 5, the first resilient plate 60 is disposed between the top panel 11 and the movable barrel 30, and is made of metal. The first resilient plate 60 defines a third through hole 610 at a center coaxial with the first through hole 110, and includes an outer closed-loop frame 611, an inner closed-loop frame 612 concentric with and surrounded by the outer closed-loop frame 611. In addition, a number of elastic parts 613 are interconnected between the outer closed-loop frame 611 and the inner closed-loop frame 612. The outer closed-loop frame 611 includes four third fixing portions 615 respectively disposed on four corners, corresponding to the four first fixing portions 111. Each of the four third fixing portions 615 is disposed between the corresponding first fixing portion 111 and the corresponding magnetic element 50, and cannot effect the movement of the spring parts 613 along the axial direction of the first accommodating room 201. The first resilient plate 60 defines four locating grooves 616 corresponding to the four fixing plates 112. The orthogonal projection of each of the four baffle plates 116 is on the first inner closed-loop frame 612 to prevent the movable barrel 30 from flying away from the first accommodating room 101.

The first inner closed-loop frame 612 defines a number of first cutouts 612a corresponding to the first locating blocks 312b and communicating with the second through hole 610. The first cutouts 612a receive the first locating blocks 312b.

The pressing plate 70 is made of non-magnetic material (such as plastic), and is disposed between the top panel 11 and the first resilient plate 60. The pressing plate 70 is substantially square-shaped, and includes four fourth fixing portions 71 corresponding to the four third fixing portions 615, and separates the top panel 11 from the first resilient plate 60 to prevent magnetic lines of the magnetic element 50 from reaching the first resilient plate 60 through the top panel 11. In other embodiments, the pressing plate 70 can be four separated blocks, and each block separates a respective fixing portion 615 from the top panel 11.

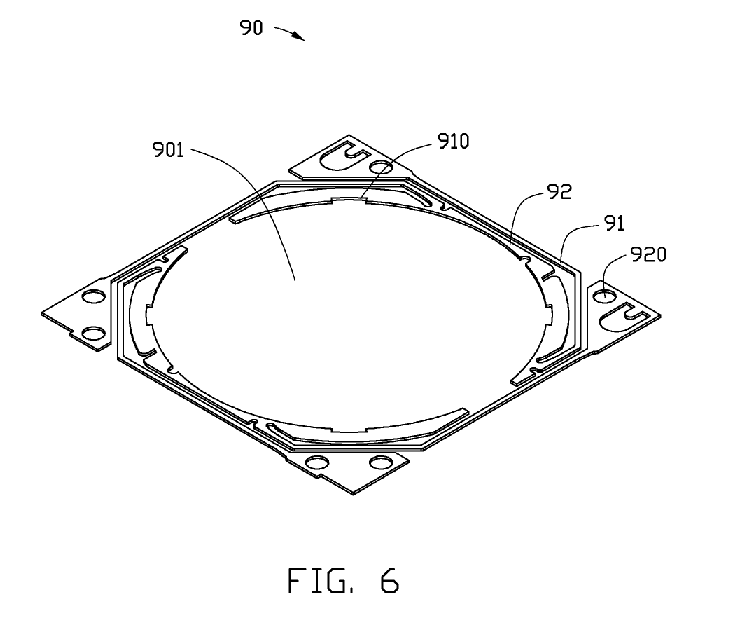

Referring also to FIG. 6, the second resilient plate 90 defines a fourth through hole 901 at a center thereof and coaxial with the first through hole 110. The second resilient plate 90 includes a second outer closed-loop frame 91 and a second inner closed-loop frame 92. The second outer closed-loop frame 91 defines a number of second cutouts 910 corresponding to the second locating blocks 313a and communicating with the fourth through hole 901. The second outer closed-loop frame 91 defines a number of locating holes 920 corresponding to the locating rods 830 on the four corners.

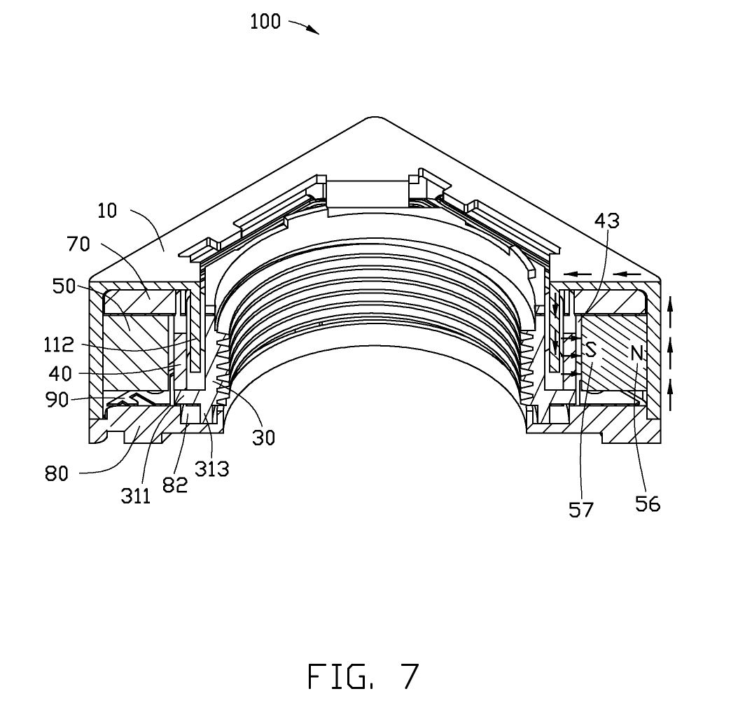

Referring to also FIG. 7, in assembly, the second resilient plate 90 is pressed on the loading plate 80, and the locating rods 830 extend through the locating holes 920. The movable barrel 30 is pressed on the second resilient plate 90. The second protrusion 313 extends through the fourth through hole 901 to be received in the slot 82. The locating blocks 313a are received in the second cutouts 910, and thus the second surface 311b resists the second inner closed-loop frame 92. The coil 41 is wrapped around an outer wall of the movable barrel 30. The four magnetic elements 50 are pressed on the four corners of the second resilient plate 90, and the inclined surfaces 52 of the magnetic elements 50 are aligned with and face and separate from the connecting surfaces 42. The third fixing portions 615 of the first resilient plate 60 are pressed on the four magnetic elements 50, and the first locating blocks 312b of the movable barrel 30 extend through the first cutouts 612a. The fourth fixing portions 71 of the pressing plate 70 are pressed on the third portions 615 of the first resilient plate 60 respectively. The housing 10 is covered on and is fixed to the loading plate 80, thus the four first fixing portions 111 firmly press the four fourth fixing portions 71 and the four third fixing portions 615 on the four magnetic elements 50. The fixing plates 112 pass through the locating groove 616 and are received in the notches 312a, with the first straight portions 112a extending through the locating grooves 616 and the second straight portions 112b being received in the notches 312a. The baffle plates 116 are positioned over the movable barrel 30 and used for preventing the movable barrel 30 from moving out of the first accommodating room 101.

In use, the magnetic lines from the N pole 56 of each magnetic element 50 pass through the corresponding perpendicular plate 12, the top panel 11, and the fixing plate 112, and then perpendicularly pass through the coil 40 to reach the S pole 57 of each magnetic element 50. When an electric current is applied to the coil 40, the coil 40 is excited to act upon the magnetic field of the magnetic elements 50, thereby receiving a magnetic force to drive the movable barrel 30 to linearly move along its central axis. When electric current is cut off from the coil 40, the first resilient plate 60 and the second resilient plate 90 apply a restoring force to the movable barrel 30, thereby returning the movable barrel 30 to its original position.

Because most portions of the magnetic lines from the magnetic element 50 can perpendicularly pass through the coil 40 to be used effectively, the number of the turns of the coil 40 can be reduced, and the volume of the voice coil motor 100 becomes more compact.

The number of the magnetic elements 50 is equal to the number of the fixing portions 111, 830, 615, 71 respectively, and the numbers of the magnetic elements 50 and the fixing portions 111, 830, 615, 71 are not limited to this embodiment.

In other embodiments, the notches 312a can be omitted, and the four fixing plates 112 are received in a gap between the movable barrel 30 and the coil 40.

In other embodiments, the locating rods 830 can be respectively glued (i.e., adhesively mounted) to the locating holes 920, the locating blocks 313a can be respectively glued (i.e., adhesively mounted) to the second cutouts 910. The first locating blocks 312b can be respectively glued (i.e., adhesively mounted) to the first cutouts 612a, the four third fixing portions 615 can be respectively glued (i.e., adhesively mounted) to the four magnetic elements 50.

In other embodiments, the first cutouts 612a are not in communication with the second through hole 610. The second cutouts 910 are not in communication with the fourth through hole 901.

In other embodiments, the pressing plate 70 can be omitted, and the first resilient plate 60 can be fixed on the four magnetic elements 50 by other methods.

It will be understood that the above particular embodiments are shown and described by way of illustration only. The principles and the features of the present disclosure may be employed in various and numerous embodiments thereof without departing from the scope of the disclosure as claimed. The above-described embodiments illustrate the scope of the disclosure but do not restrict the scope of the disclosure.

What is claimed is:

1. A voice coil motor comprising:
a loading plate;
a housing covering on the loading plate and defining a first accommodating room, the housing comprising:
a top panel;
at least two peripheral panels substantially perpendicularly connected to the top panel; and
at least two fixing plates, each fixing plate being positioned on a respective one of the at least two peripheral panels and extending in the first accommodating room;
a movable barrel movably received in the first accommodating room;
at least two magnetic elements received in the first accommodating room and surrounding the movable barrel, each of the at least two magnetic elements having a first magnetic pole aligned with a corresponding one of the at least two fixing plates and a second magnetic pole fixed on the housing; and
a coil sleeved on the movable barrel and positioned between the at least two fixing plates and the first magnetic poles of the at least two magnetic elements, the coil separating from the first magnetic poles of the at least two magnetic elements.

2. The voice coil motor of claim 1, wherein the voice coil motor further comprises a first resilient plate and a pressing plate, the first resilient plate is positioned on the at least two magnetic elements, the pressing plate is made of non-magnetic material and positioned between the first resilient plate and the top panel, the first resilient plate defines at least two locating grooves, the at least two fixing plates extend through the at least two locating grooves to be received between the coil and the movable barrel.

3. The voice coil motor of claim 2, wherein each fixing plate comprises a first straight portion adjacent to the top panel and a second straight portion extending from the first straight portion, the first straight portion has a first wide edge, the second straight portion has a second wide edge, the first wide edge and the second wide edge are perpendicular to a central axis of the housing, a length of the first wide edge is shorter than that of the second wide edge, the first straight portion extends through a respective locating groove, the second straight portion is positioned between the coil and the movable barrel.

4. The voice coil motor of claim 2, wherein the top panel comprises at least two first fixing portions, the loading plate comprises at least two second fixing portions, the first resilient plate comprises a first outer closed-loop frame having at least two third fixing portions, the pressing plate comprises at least two fourth fixing portions, each of the at least two first fixing portions is positioned on a respective one of the at least two fourth fixing portions, each of the at least two second fixing portions connects to one side of a respective one of the at least two magnetic elements, each of the at least two third fixing portions is positioned on another side of a respective one of the at least two magnetic elements, each of the at least two fourth fixing portions is positioned between a respective one of the at least two first fixing portions and a respective one of the at least two third fixing portions.

5. The voice coil motor of claim 4, wherein the first resilient plate further comprises a first inner closed-loop frame concentric with and surrounded by the first outer closed-loop frame, and a plurality of elastic parts interconnected between the first outer closed-loop frame and the first inner closed-loop frame.

6. The voice coil motor of claim 5, wherein the top panel further comprises at least two baffle plates extending in the first accommodating room, orthogonal projections of the at least two battle plates are on the first inner closed-loop frame and configured to prevent the movable barrel from moving out of the first accommodating room.

7. The voice coil motor of claim 5, wherein the movable barrel comprises a base and a first protrusion extending from the base towards the top panel, the movable barrel comprises a first surface on the base and facing the top panel, the coil surrounds the first protrusion and is loaded on the first surface.

8. The voice coil motor of claim 7, wherein the first protrusion comprises a surface which faces the first resilient plate and projects a plurality of first locating blocks, the first inner closed-loop frame defines a plurality of first cutouts spatially corresponding to the first locating blocks, each of the first locating blocks is received in a respective one of the first cutouts.

9. The voice coil motor of claim 7, wherein the first protrusion has at least two sidewalls spatially corresponding to the at least two fixing plates, each of the at least two sidewalls defines a notch, the notch receives a corresponding fixing plate.

10. The voice coil motor of claim 7, wherein the top panel defines a first through hole at a center thereof, the loading plate defines a second through hole at the center thereof, the first resilient plate defines a third through hole at the center thereof, the voice coil motor further comprises a second resilient plate between the movable barrel and the loading plate, the second resilient defines a fourth through hole at a center thereof, the movable barrel defines a second accommodating room extending all the way through thereof, all of the first through hole, the second through hole, the third through hole, the fourth through hole, and the second accommodating room are coaxial with each other.

11. The voice coil motor of claim 10, wherein the second resilient plate further comprises a second outer closed-loop frame defining a plurality of locating holes, the loading plate arranges a plurality of locating rods spatially corresponding to the locating holes, each locating rod passes through a respective one of the locating holes.

12. The voice coil motor of claim 10, wherein the second resilient plate further comprises a second inner closed-loop frame concentric with and surrounded by the second outer closed-loop frame, the second inner closed-loop frame defines a plurality of second cutouts, the movable barrel further comprises a second protrusion extending from the base towards the loading plate, the second protrusion passes through the fourth through hole and is positioned on the loading plate, an outer surface of the second protrusion arranges a plurality of second locating blocks, each second locating block is received in a respective one of the second cutouts.

13. The voice coil motor of claim 12, wherein the loading plate defines a ring-shaped slot, the movable barrel comprises a second surface on the base and facing the loading plate, the second protrusion passes through the fourth through hole to be received in the ring-shaped slot, and thus the second surface resists the second resilient plate.

14. The voice coil motor of claim 1, wherein each of the at least two magnetic elements are substantially right triangle-shaped, and comprises two third surfaces perpendicular to each other and a fourth surface connected between the two third surfaces, the two third surfaces touch the housing, the fourth surface faces the coil and separates from the coil.

15. The voice coil motor of claim 1, wherein the housing is made of high permeability alloy.
